(19) United States
(12) Patent Application Publication
(10) Pub. No.: US 2022/0016842 A1
(43) Pub. Date: Jan. 20, 2022

(54) DETERMINING A THERMAL FOOTPRINT FOR A THREE-DIMENSIONAL PRINTED PART

(71) Applicants: HEWLETT-PACKARD DEVELOPMENT COMPANY, L.P., Spring, TX (US); INSTITUTO ATLANTICO, Fortaleza-Ceará (BR)

(72) Inventors: Maria Fabiola LEYVA MENDIVIL, Guadalajara (MX); Juan Carlos CATANA SALAZA, Guadalajara (MX); Alyne Gomes Soares CANTAL, Fortaleza (BR); Jun ZENG, Palo Alto, CA (US)

(21) Appl. No.: 17/299,637

(22) PCT Filed: Dec. 19, 2018
(86) PCT No.: PCT/US2018/066570

§ 371 Date: Jun. 3, 2021

(51) Int. Cl. B29C 64/386; G06F 30/23; G01K 3/14; B33Y 50/00

(52) U.S. Cl. CPC B29C 64/386; B33Y 50/00; G01K 3/14; G06F 30/23

(57) ABSTRACT

In an example of a method for determining a thermal footprint for a three-dimensional (3D) printed part, a part to be printed by a 3D printer is identified. A thermal footprint for the part is determined based on part geometry and heat transfer associated with printing the part.

### BACKGROUND

In three-dimensional (3D) printing, 3D solid parts may be produced from a digital model using an additive printing process. 3D printing may be used in rapid prototyping, mold generation, mold master generation, and short-run manufacturing. Some 3D-printing techniques are considered additive processes because they involve the application of successive layers of material. Moreover, some 3D printing systems may concurrently build multiple 3D solid parts in the build volume as part of a common build operation.

### BRIEF DESCRIPTION OF THE DRAWINGS

FIG. 1 is a simplified isometric view of an example of a 3D-printing system that may be used in an example of a 3D-printing method;

FIG. 2 is a block diagram of an example of an apparatus that may be used in an example of a method for determining a thermal footprint for a 3D printed part;

FIG. 3 is a flow diagram illustrating an example of a method for determining a thermal footprint for a 3D printed part;

FIG. 4 is a flow diagram illustrating an example of a method for determining a packing solution for 3D printed parts based on a thermal footprint; and

FIG. 5 is a flow diagram illustrating another example of a method for determining a thermal footprint for a 3D printed part.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

In some 3D-printing processes, materials may be heated, melted, and cooled. In manufacturing settings, build volumes may be largely full, parts may be diverse and densely packed, and the part count may be on the order of hundreds of parts within a single build volume. The thermal experience of the build volume may be influenced by the placement (i.e., concentration and distribution) of agents (e.g., fusing agents, detailing agents, coloring agents, and/or other types of agents that can influence thermal energy received by the build material) inside the build volume. The placement of agents may be influenced by the placement and orientation of the parts.

When multiple parts are printed concurrently in the same build volume or build envelope, part-to-part consistency may depend on the heat transfer experienced by the printed parts. The heat generated during printing of a part may impact another part if the heat transfer is not accounted for. Therefore, a thermal footprint of multiple parts in a build volume may influence the part packing in the build volume.

This disclosure describes some examples of determining a thermal footprint for a 3D printed part in a build volume. The thermal footprint may be used to determine the packing of parts in the build volume. This disclosure is further related to a 3D printer capable of printing multiple parts of different geometry. A system is described that calculates the thermal footprint (also referred to as thermal aura) of different parts to be packed into the 3D printer. The system dynamically determines the spacing and thermal footprint for each part based on the part geometry (e.g., size, shape, geometrical complexity, etc.) and heat transfer associated with printing the part. The system may provide better packing density according to the heat transfer and geometry of different parts. The system may also provide optimization for part quality and packing density.

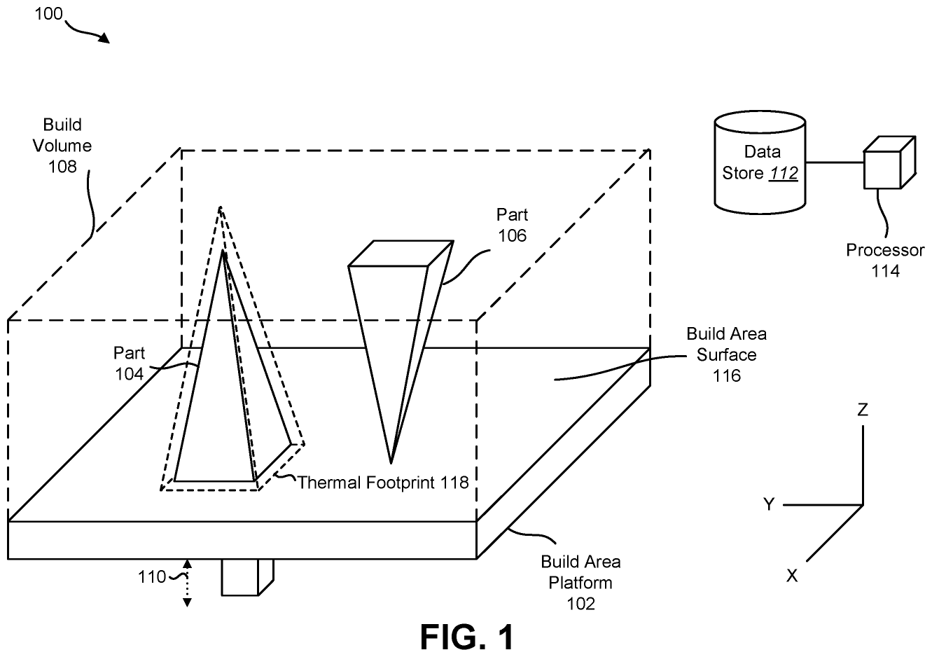

FIG. 1 is a simplified isometric view of an example of a 3D-printing system 100 that may be used in an example of a 3D-printing method. The 3D-printing system 100 may include a build area platform 102 that includes a build area surface on which part 104 and part 106 (also referred to as 3D parts or 3D objects) are generated from materials (not shown) such as build materials, agents, etc. In FIG. 1, two parts (part 104 and part 106) are shown for purposes of illustration. In other examples, more or fewer parts may be used.

Parts 104 and 106 may be generated within a build volume 108 (also referred to as a build envelope). The build volume 108 may occupy a 3D space on top of the build area surface 116 of the build area platform 102. For instance, the build volume 108 may be the 3D space in which the 3D-printing system 100 may print or otherwise generate parts 104 and 106. The width and length of the build volume 108 may be constrained by the width and length of the build area platform 102. The height of the build volume 108 may be constrained by the amount the build area platform 102 may be moved in the z direction, where movement of the build area platform 102 in the z direction is represented by arrow 110.

The 3D-printing system 100 may print multiple parts 104 and 106 during a common printing operation (i.e., a single building operation within the build volume 108). The arrangement (e.g., location and orientation) of the parts 104 and/or 106 in the build volume 108 may be referred to as the packing solution, parts packing or packing. The arrangement of a part 104 and/or 106 in the build volume 108 may include the placement or location of the part 104 and/or 106, and the orientation of the part 104 and/or 106 (e.g., yaw, pitch, and roll).

In some examples, the 3D-printing system 100 may be a powder bed fusion system. Examples of a powder bed fusion system include multi jet fusion (MJF), selective laser sintering (SLS), direct metal laser sintering (DMLS), selective laser melting (SLM), etc. With powder bed fusion, the 3D-printing system 100 may use a heat source (e.g., infrared hear source, laser, electron beam, etc.) to melt a powdered material (e.g., plastic, metal) in the build volume 108. In some examples, parts (e.g., part 104 and part 106) may be printed in layers. For example, a layer of powder may be spread on the build area surface 116. The heat source may pass over the powder, which fuses to form a part. This process may be repeated until the parts are completed.

In the case of MJF, a layer of powder may be first spread over the build area surface 116. The powder may be heated to a near-sintering temperature. A printhead(s) with a nozzle(s) (e.g., inkjet nozzle) may pass over the build area surface 116. The printhead may deposit fusing agent (FA) on the powder to promote powder fusion in areas where the part is to be formed. The nozzles may also deposit detailing agent (DA) in areas (e.g., near the edge of the part) where fusion is to be inhibited. A heat source (e.g., infrared hear source) may then pass over the build area surface 116 and fuse the areas where the FA is applied while leaving the remaining powder unaltered. The MJF process may progress through multiple layers until the parts are complete.

The 3D-printing system 100 may include a processor 114. In some examples, the processor 114 may be a computing device, a semiconductor-based microprocessor, a central processing unit (CPU), a graphics processing unit (GPU), field-programmable gate array (FPGA), an application-specific integrated circuit (ASIC), and/or other hardware device. The processor 114 may be connected to other components of the 3D-printing system 100 via communication lines (not shown).

The processor 114 may control actuators (not shown) to control operations of the components of the 3D-printing system 100. For example, the processor 114 may further control actuators that control the movement of build material from a storage location (not shown) to a position to be spread onto the build area surface 116 and/or a previously formed layer of build material. The processor 114 may also control actuators that control the deposition and spreading of build material across the build area surface 116 and/or the previously formed layer of build material. The processor 114 may also control actuators that control the feeding of agents (e.g., fusing agents, detailing agents, coloring agents, other agents, etc.) into the printhead(s). The processor 114 may additionally control actuators that control the application of agents to the build material. The processor 114 may also control actuators that control application of energy to the agents and build material. The processor 114 may further control actuators that raise and lower the build area platform 102 along the z direction.

The processor 114 may communicate with a data store 112. The data store 112 may be a machine-readable storage medium. Machine-readable storage may be any electronic, magnetic, optical, or other physical storage device that stores executable instructions. Thus, a machine-readable storage medium may be, for example, Random-Access Memory (RAM), an Electrically Erasable Programmable Read-Only Memory (EEPROM), Magnetoresistive Random-Access Memory (MRAM), a storage drive, an optical disc, and the like. The data store 112 may be referred to as memory.

The data store 112 may include data pertaining to part 104 and/or part 106 to be printed by the 3D-printing system 100. For example, the data store 112 may store data pertaining to the geometry of part 104 and/or part 106. The data store 112 may also store data pertaining to the location and orientation of the part 104 and/or part 106 in the build volume 108. As described below, machine-readable storage medium may also be encoded with executable instructions for determining the thermal footprint 118 of a part. For example, the data store 112 may include machine-readable instructions that cause the processor 114 to determine the thermal footprint 118 for the part 104 based on part geometry and heat transfer associated with printing the part 104. In FIG. 1, the thermal footprint 118 for one part 104 is shown for purposes of illustration. In other examples, the processor 114 may determine the thermal footprint for other parts (e.g., part 106) that are to be printed in the build volume 108.

In one example, the data store 112 may further include machine-readable instructions that cause the processor 114 to determine the thermal footprint 118 by performing a finite element analysis to simulate a transient heat transfer associated with printing the part 104 based on a voxel representation of the part 104. In some examples, voxels in the voxel representation may be used as primitive elements for the finite element analysis. A boundary of the thermal footprint 118 may be based on the heat transfer associated with printing the part 104 by a powder bed fusion 3D printer (e.g., MJF printer, SLS printer, etc.).

In an example, the machine-readable instructions may cause the processor 114 to simulate the transient heat transfer associated with printing the part 104. The machine-readable instructions may further cause the processor 114 to determine a volume surrounding the part 104 that includes calculated temperatures that exceed a thermal index threshold. The thermal footprint 118 may be this volume that includes the calculated temperatures exceeding the thermal index threshold. In some examples, the thermal index threshold may be a user-selectable threshold that sets a maximum temperature at the boundary of the thermal footprint 118.

In an example, the machine-readable instructions to simulate the transient heat transfer associated with printing the part 104 may include machine-readable instructions to simulate a transient heat transfer associated with printing multiple layers of the part 104. For example, the transient heat transfer simulation may account for heating and cooling effects associated with printing multiple layers of the part 104.

In another example, the machine-readable instructions to simulate the transient heat transfer associated with printing the part 104 may include machine-readable instructions to simulate the transient heat transfer for a heat source from a complete part 104. In this example, the thermal simulation may be a bulk part simulation that treats the entire part 104 as a thermal source. This approach may discard temperature differences resulting from burying fusing layers.

In yet another example, the machine-readable instructions to simulate the transient heat transfer associated with printing the part 104 may include machine-readable instructions to define a thermal footprint distance (also referred to as a thermal bleed distance). In this approach, the thermal footprint 118 may be generated by growing the part 104 following the surface normal outwards to a certain distance (e.g., the thermal footprint distance).

In another example, the machine-readable instructions may cause the processor 114 to determine a packing solution for the build volume 108 based on the thermal footprint 118. For example, the processor 114 may determine an orientation and location of the part 104 in relation to other parts (e.g., part 106) in the build volume 108 based on the thermal footprint 118 of the part 104. The processor 114 may also determine the thermal footprint 118 for the part based further on an orientation of the part 104 in the build volume 108. For example, the heat transfer associated with printing the part 104 may vary based on the orientation of the part 104 in the build volume 108. The processor 114 may evaluate different orientations of the part 104 to determine a thermal footprint 118 that optimizes the packing solution.

Various aspects may be considered with respect to the packing solution for 3D printing. In one aspect, the parts packing may be tailored to address the heat transfer associated with 3D printing to provide an acceptable yield after printing. In another aspect, packing density may be maximized to increase the throughput (and decrease costs) associated with 3D printing. These aspects may be optimized by determining the packing solution for the build volume 108 based on the thermal footprint 118.

In a further example, the machine-readable instructions may cause the processor 114 to optimize the part packing density and detailing agent usage based on the thermal footprint 118. As used herein, the part packing density is related to the inter-part spacing within the build volume 108. As the spacing between parts decreases, the part packing density increases. Conversely, as the spacing between parts increases, the part packing density decreases. More parts may be printed in a build volume 108 if detailing agent (DA) is used. However, the use of DA may have a system-wide negative impact. For example, DA usage may reduce the lifespan of the printheads.

The part packing density and detailing agent usage may be based on the thermal index threshold. The processor 114 may determine an optimal balance between the part packing density and detailing agent usage based on the thermal footprint 118. In some examples, DA usage may be minimized or eliminated by using a thermal footprint 118 that ensures that the mutual heat transfer from printed parts does not result in temperatures exceeding a thermal index threshold.

The 3D-printing system 100 may include additional components (not shown). Further, some of the components described herein may be removed and/or modified without departing from the scope of this disclosure. The 3D-printing system 100 as depicted in FIG. 1 may not be drawn to scale and may have a different size and/or configuration than shown. For instance, the 3D-printing system 100 may include material ejecting devices to generate 3D objects with more than two different types of materials. In another example, the 3D-printing system 100 may use any of a number of different additive manufacturing techniques to build or print parts 104, 106. For example, the 3D-printing system 100 may employ any of multijet fusion, selective laser sintering, selective laser melting, stereolithography, etc. Moreover, various types of materials, e.g., power-based, liquid-based, etc., may be used by the 3D-printing system 100. For instance, thermoplastics (TCP) such as polyamide 12/nylon 12 (PA12), etc. may be used.

In addition, the apparatuses disclosed herein to determine the thermal footprint 118 and/or the printing solution (e.g., the placement and the orientation of parts to be printed) may be external to the 3D-printing system 100. For instance, the apparatuses disclosed herein may be computing devices that are to determine the thermal footprint 118 and/or the printing solution. The disclosed apparatuses may communicate the determined thermal footprint 118 and printing solution to the 3D-printing system 100 or additive manufacturing system.

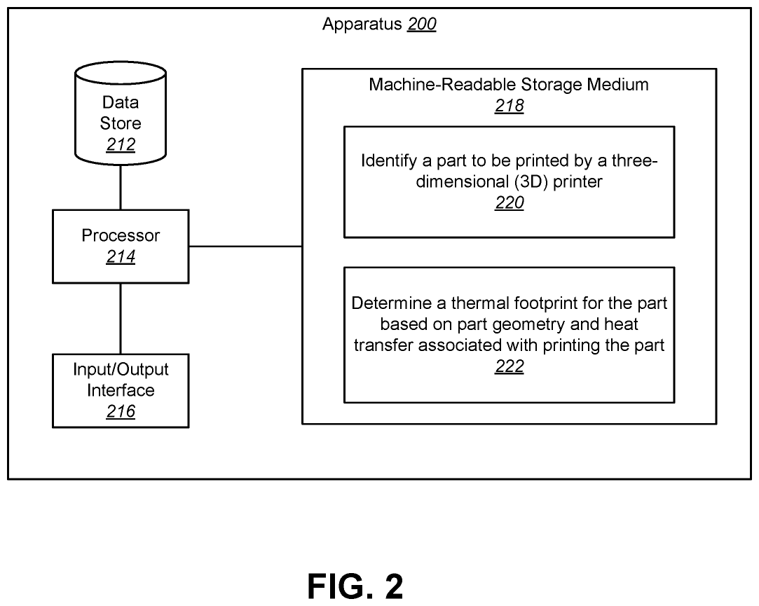

FIG. 2 is a block diagram of an example of an apparatus 200 that may be used in an example of a method for determining a thermal footprint for a 3D printed part. The apparatus 200 may be a computing device, such as a personal computer, a server computer, a printer, a 3D printer, a smartphone, a tablet computer, etc. In an example, the apparatus 200 may be equivalent to the processor 114 depicted in FIG. 1. The apparatus 200 may include a processor 214, a data store 212, an input/output interface 216, and a machine-readable storage medium 218. The apparatus 200 may further include additional components (not shown) and some of the components described herein may be removed and/or modified without departing from the scope of this disclosure.

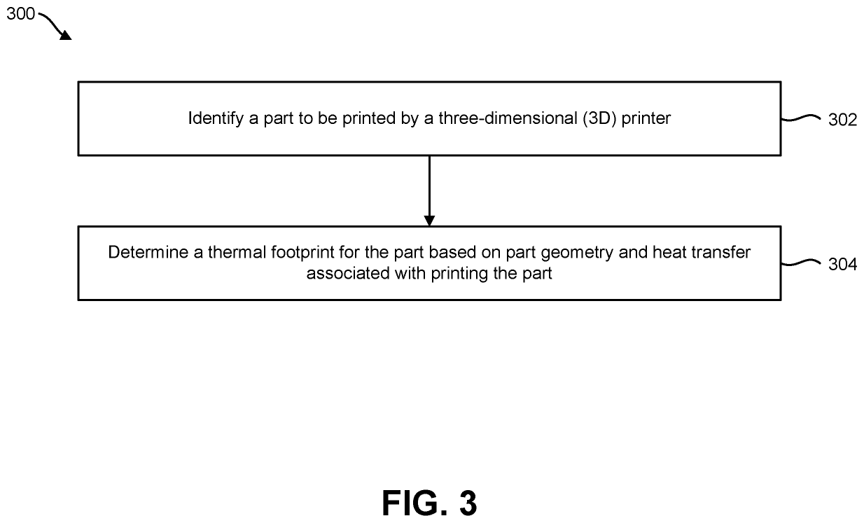

The processor 214 may be any of a central processing unit (CPU), a semiconductor-based microprocessor, GPU, FPGA, an application-specific integrated circuit (ASIC), and/or other hardware devices suitable for retrieval and execution of instructions stored in the machine-readable storage medium 218. The processor 214 may fetch, decode, and execute instructions, such as instructions 220-222 stored on the machine-readable storage medium 218, to control processes to identify 220 a part to be printed by a three-dimensional (3D) printer and determine 222 a thermal footprint for the part based on part geometry and heat transfer associated with printing the part. As an alternative or in addition to retrieving and executing instructions, the processor 214 may include an electronic circuit and/or electronic circuits that include electronic components for performing the functionalities of the instructions 220-222. These processes are described in detail below with respect to FIGS. 3-5.

The machine-readable storage medium 218 may be any electronic, magnetic, optical, or other physical storage device that contains or stores executable instructions. Thus, the machine-readable storage medium 218 may be, for example, RAM, EEPROM, a storage device, an optical disc, and the like. In some implementations, the machine-readable storage medium 218 may be a non-transitory machine-readable storage medium, where the term “non-transitory” does not encompass transitory propagating signals.

The apparatus 200 may also include a data store 212 on which the processor 214 may store information, such as information pertaining to the parts to be printed. The data store 212 may be volatile and/or non-volatile memory, such as DRAM, EEPROM, MRAM, phase change RAM (PCRAM), memristor, flash memory, and the like.

The apparatus 200 may further include an input/output interface 216 through which the processor 214 may communicate with an external device(s) (not shown), for instance, to receive and store the information pertaining to the parts to be printed. The input/output interface 216 may include hardware and/or machine-readable instructions to enable the processor 214 to communicate with the external device(s). The input/output interface 216 may enable a wired or wireless connection to the output device(s). The input/output interface 216 may further include a network interface card and/or may also include hardware and/or machine-readable instructions to enable the processor 214 to communicate with various input and/or output devices, such as a keyboard, a mouse, a display, another computing device, etc., through which a user may input instructions into the apparatus 200.

FIG. 3 is a flow diagram illustrating an example of a method 300 for determining a thermal footprint 118 for a 3D printed part 104. The method 300 for determining the thermal footprint 118 may be performed by, for example, the processor 114 and/or the apparatus 200. The apparatus may identify 302 a part 104 to be printed. For example, the apparatus may receive a 3D model of a part 104. In some examples, the apparatus may receive a set of parts in a part list. The 3D model of the part 104 may be cached in a data store 112.

The apparatus may determine 304 a thermal footprint 118 for the part 104 based on part geometry and heat transfer associated with printing the part 104. In one example, the apparatus may generate a voxel representation of the part 104. A voxelization procedure may be applied to discretize the part volume into regular-shaped voxels (e.g., cubic shaped voxels). Regular-shaped voxels may be used as the primitive element in a finite element analysis to construct a transient thermal simulation. This transient thermal simulation may gauge the worst-case impact of the thermal bleed from the part 104 to other parts in the build volume 108.

In some examples, the apparatus may perform a finite element analysis of the transient heat transfer associated with printing the part 104. The finite element analysis may be performed using a mesh that includes the voxels of the part 104 and powder surrounding the part. The finite element analysis may determine temperatures within the part 104 and the surrounding powder that may occur during the printing process. The finite element analysis may generate a thermal map of the part 104 and the surrounding powder based on part geometry (e.g., the part size, shape, geometrical complexity and/or location of the part 104 within the build volume 108).

Based on the synthesized thermal map that gauges the worst-case impact of the thermal bleed, a volume may be extracted based on a user-defined thermal index threshold. This volume may include temperatures that exceed the thermal index threshold. This volume is the thermal footprint 118. In other words, the thermal footprint 118 may include voxels of the part 104 and surrounding powder that are calculated to have a temperature exceeding the thermal index threshold.

In some approaches, a user may specify different values for the thermal index threshold, which results in different levels of aggressiveness for the thermal footprint 118. The thermal index threshold may indicate a maximum temperature at the boundary of the thermal footprint 118. The higher the thermal index threshold, the closer the thermal footprint 118 volume will be converged to part shape.

In some approaches, the thermal index threshold may also determine packing density and the amount of DA used for compensation. The higher the thermal index threshold is set, the closer the volume of thermal footprint 118 gets to the part volume. In other words, a high thermal index threshold may result in a higher packing density, but more DA to compensate for increases in thermal bleed. This may result in a Pareto-optimization. In this context, Pareto optimality or Pareto efficiency may be a state in which optimizing one objective decreases the optimization of at least one other objective.

The thermal footprint 118 not only completely encapsulates the part 104 but also provides additional volume to separate other parts (e.g., part 106) potentially to be placed close to the part 104 in the build volume 108. Therefore the thermal footprint 118 may depend on the part geometry (e.g., part size, shape, geometrical complexity, build location) and thermal properties (e.g., heat transfer associated with printing the part 104).

In some examples, the distance between the part surface and the boundary of the thermal footprint 118 may vary based on the calculated heat transfer at different locations on the part 104. Therefore, in these examples, the thermal footprint 118 does not have a fixed offset from the surface of the part 104.

Different types of thermal simulations may be used to determine the maximum heat temperatures due to heat transfer and to provide efficient computing. In some approaches, simulating the transient heat transfer associated with printing the part 104 may include simulating a transient heat transfer associated with printing multiple layers of the part 104. A transient layer-wise thermal simulation may mimic the printing process (e.g., MJF part production process). For example, the transient heat transfer may be simulated on a layer-by-layer basis. This transient heat transfer simulation may account for heating and cooling effects associated with printing multiple layers of the part 104.

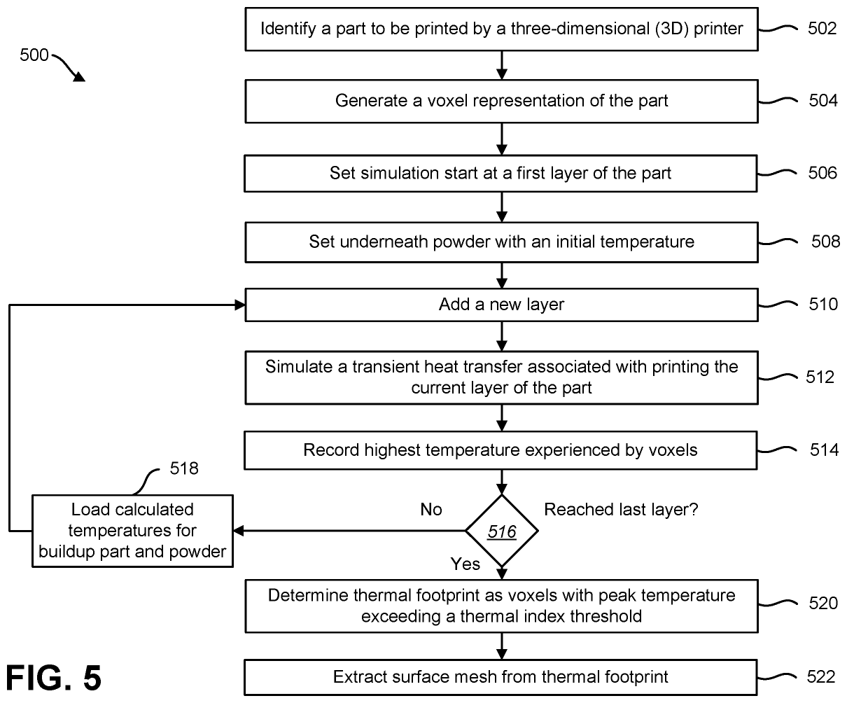

In some examples, to shorten the computational time, multiple production layers (e.g., multiple printed layers) may be grouped into a single computational layer for acceleration of the transient heat transfer simulation. Additionally, the complex energy absorption procedure and phase change procedure may be further simplified to afford a quick assessment. An example of determining the thermal footprint 118 based on this layer-by-layer transient heat transfer simulation is described in connection with FIG. 5.

In some examples, simulating the transient heat transfer associated with printing the part 104 may include simulating a transient heat transfer for a heat source from a complete part 104. For example, the thermal simulation may be performed as a bulk part simulation that treats the entire part 104 as a thermal source. This approach may discard the temperature difference resulting from burying fusing layers. This approach may be faster than the layer-by-layer approach, but may provide an assessment of the thermal bleed impact that is less precise. This may result in less space saving for part packing (e.g., a slight reduction of packing density, and/or a slight increase in using DA), but reduces the computation time for simulating the transient heat transfer. Therefore, the thermal footprint 118 simulation may provide another Pareto-optimization between: 1) computational cost and 2) the tightness of the worst-case bound of the thermal bleed impact which is further impacted by incremental packing density loss and/or DA usage.

Depending on the different methods to simulate the thermal process, the thermal footprint 118 may depend on the orientation of the part 104 when packed for production. For instance, the layer-by-layer thermal simulation implementation may result in a different thermal footprint 118 if the same part 104 orients its z-normal differently. In this case, the thermal footprint 118 may be pre-computed for different z-orientations and then stored.

In the case that the bulk thermal impact (e.g., not layer-by-layer) is simulated, the thermal footprint 118 may be computed once. The thermal footprint 118 may then be rotated depending on the orientation determined by the packing solution.

In some examples, the thermal footprint 118 may be generated with a defined thermal bleed distance. In these examples, the thermal footprint 118 may be generated by growing the part 104 following the surface normal outwards to the thermal bleed distance. In this case, the thermal bleed distance may be determined by the user-defined thermal index threshold.

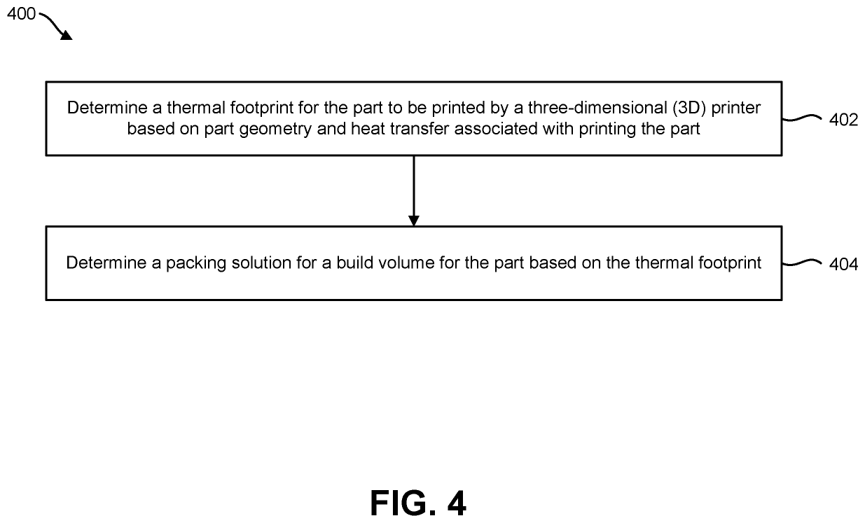

FIG. 4 is a flow diagram illustrating an example of a method 400 for determining a packing solution for 3D printed parts based on a thermal footprint 118. The method 400 for determining the packing solution based on the thermal footprint 118 may be performed by, for example, the processor 114 and/or the apparatus 200. The apparatus may determine 402 a thermal footprint 118 for a part to be printed by a 3D printer based on part geometry and heat transfer associated with printing the part. This may be accomplished as described in connection with FIGS. 1-3.

In some examples, the apparatus may determine 402 the thermal footprint 118 for multiple parts that are to be printed in a single build volume 108. For example, the apparatus may determine 402 the thermal footprint 118 for a set of parts in a part list. The apparatus may save the thermal footprints 118 for the multiple parts.

The apparatus may determine 404 a packing solution for the build volume 108 based on the thermal footprint 118. In some examples, the thermal footprint 118 may represent each part 104 by a group of voxels. This voxel representation may be directly applied for geometrical part packing optimization. Additionally, a surface boundary extraction procedure may be applied to the volumetric representation of the thermal footprint 118 to generate a boundary representation of the thermal footprint 118. This boundary representation may be applied with a packing approach that uses a boundary representation to describe the volume.

The packing solution based on the volume of the thermal footprint 118 (e.g., either a voxel representation or mesh representation) may be translated into a packing solution based on parts by aligning the orientation and location of thermal footprints 118 of the parts. The thermal footprints 118 may then be replaced with its corresponding part. The resulting packing solution is then ready for printing.

During the packing solution determination, the orientation and placement of the thermal footprints 118 may be recorded. A part (e.g., part 104 and/or part 106) may then be oriented and translated accordingly to fit into the packed solution replacing thermal footprint 118 for production. It should be noted that while the orientation of the thermal footprint 118 and the corresponding part alignment are explicit, the translation of the thermal footprint 118 and part alignment may be based on a pre-defined fiducial point during thermal footprint generation. In other words, the center of the part within the thermal footprint 118 may differ from the center of the thermal footprint 118.

FIG. 5 is a flow diagram illustrating another example of a method 500 for determining a thermal footprint 118 for a 3D printed part 104. The method 500 for determining the thermal footprint 118 may be performed by, for example, the processor 114 and/or the apparatus 200. In some examples, the method 500 may be implemented as a part-level pre-process flow. An objective of the thermal simulation described in method 500 is to assess the worst-case of the thermal bleed from a printed part 104 under the constraints of computational time/resources while noting that, for a given batch, there may be multiple parts (e.g., hundreds) that go through the same computational flow and carry a similar computational burden.

The apparatus may identify 502 a part 104 to be printed by a 3D printer. For example, the apparatus may receive a 3D model of a part 104. In some examples, the apparatus may receive a set of parts in a part list. The 3D model of the part 104 may be cached in a data store 112.

The apparatus may generate 504 a voxel representation (also referred to as a voxel profile) of the part 104. The voxelization process may be performed to discretize the part volume. Each voxel may be converted into a finite element for thermal simulation. The voxel representation may be saved to the data store 112. The apparatus may load the voxel representation and input parameters into the data store 112. The apparatus may set the transient, layer-wise thermal simulation domain. In some examples, the transient, layer-wise thermal simulation domain may include a bounding box that includes the part 104 and powder surrounding the part.

The apparatus may set 506 the simulation to start at the first layer of the part 104. For example, the part may be printed in multiple layers. The apparatus may set 506 the simulation to start at the first layer. In some examples, to shorten the computational time, multiple production layers (e.g., multiple printed layers) may be grouped into a single computational layer for acceleration of the transient heat transfer simulation.

The apparatus may set 508 the underneath powder with an initial temperature. This initial temperature may be an amount that the powder is pre-heated before fusion of the part occurs in the first layer.

The apparatus may add 510 a new layer. At the start of the simulation, the new layer is the first layer of the part 104. The new layer may be added with the initial powder temperature and fused powder temperature. The new layer may include the voxel representation of the part and the surrounding powder for that layer.

The apparatus may simulate the transient heat transfer associated with printing the current layer of the part 104. For example, the apparatus may perform a finite element analysis using the voxel representation of the part 104 and surrounding powder to determine temperatures of the voxels in response to printing the current layer. The apparatus may record 514 the highest temperature experienced by each voxel.

The apparatus may determine 516 whether the last layer has been reached. If the last layer has not been reached, the apparatus may load 518 calculated temperatures for a buildup of the part 104 and powder. The apparatus may then add 510 a new (e.g., next) layer of the part 104. The apparatus may simulate 512 the transient heat transfer and record 514 the highest temperatures for the new layer and previously printed layers.

If the apparatus determines 516 that the last layer has been reached, then the apparatus may determine 520 the thermal footprint 118 as voxels whose peak temperature exceeds a thermal index threshold. In some examples, the thermal footprint 118 may be a 3D model that includes the voxels that are identified as having a peak temperature that exceeds the thermal index threshold.

In some examples, the apparatus may extract 522 a surface mesh representation of the thermal footprint 118. For example, a surface boundary extraction procedure may be applied to the volumetric representation of the thermal footprint 118 to generate a boundary representation of the thermal footprint 118.

1. A method, comprising:
identifying a part to be printed by a three-dimensional (3D) printer; and
determining a thermal footprint for the part based on part geometry and heat transfer associated with printing the part.

2. The method of claim 1, wherein determining the thermal footprint comprises performing a finite element analysis to simulate a transient heat transfer associated with printing the part based on a voxel representation of the part.

3. The method of claim 2, wherein voxels in the voxel representation are used as primitive elements for the finite element analysis.

4. The method of claim 1, wherein a boundary of the thermal footprint is based on the heat transfer associated with printing the part by a powder bed fusion 3D printer.

5. The method of claim 1, wherein determining the thermal footprint comprises:
simulating a transient heat transfer associated with printing the part; and
determining a volume surrounding the part that includes calculated temperatures that exceed a thermal index threshold.

6. A computing device, comprising:
a memory;
a processor coupled to the memory, wherein the processor is to:
determine a thermal footprint for a part to be printed by a three-dimensional (3D) printer based on part geometry and heat transfer associated with printing the part; and
determine a packing solution for a build volume based on the thermal footprint.

7. The computing device of claim 6, wherein the processor is to determine an orientation and location of the part in relation to other parts in the build volume based on the thermal footprint of the part.

8. The computing device of claim 6, wherein the processor is to optimize part packing density and detailing agent usage based on the thermal footprint.

9. The computing device of claim 8, wherein the part packing density and detailing agent usage are based on a thermal index threshold.

10. The computing device of claim 6, wherein the processor is to determine the thermal footprint for the part based further on a user-selectable thermal index threshold that sets a maximum temperature at a boundary of the thermal footprint.

11. The computing device of claim 6, wherein the processor is to determine the thermal footprint for the part based further on an orientation of the part in the build volume for the part.

12. A non-transitory machine-readable storage medium encoded with instructions executable by a processor, the machine-readable storage medium comprising:
instructions to identify a part to be printed by a three-dimensional (3D) printer;
instructions to simulate a transient heat transfer associated with printing the part; and
instructions to determine a thermal footprint comprising a volume surrounding the part that includes calculated temperatures that exceed a thermal index threshold.

13. The machine-readable storage medium of claim 12, wherein the instructions to simulate the transient heat transfer associated with printing the part comprise instructions to simulate a transient heat transfer associated with printing multiple layers of the part.

14. The machine-readable storage medium of claim 13, wherein the transient heat transfer simulation accounts for heating and cooling effects associated with printing multiple layers of the part.

15. The machine-readable storage medium of claim 12, the instructions to simulate the transient heat transfer associated with printing the part comprise instructions to simulate a transient heat transfer for a heat source from a complete part.
